(19) United States
(12) Patent Application Publication
(10) Pub. No.: US 2022/0156449 A1
(43) Pub. Date: May 19, 2022

(54) SYSTEM AND METHOD FOR PROVIDING STEGANOGRAPHIC TEXT ENCODING

(71) Applicant: Crosstech Solutions Group LLC, Moscow (RU)

(72) Inventor: Yevgeniy I Chugunov, Moscow (RU)

(21) Appl. No.: 17/189,689

(22) Filed: Mar. 2, 2021

(30) Foreign Application Priority Data
Sep. 4, 2020 (RU) 2020129344

(51) Int. Cl. G06F 40/126; G06F 21/62; H04L 12/58; H04L 29/08

(52) U.S. Cl. CPC G06F 40/126; G06F 21/6218; G06F 2221/2141; H04L 67/06; H04L 51/00

(57) ABSTRACT

A method a method for steganographic text encoding, includes converting a message text received from a server into a plurality of binary values. The text of the document represented by the plurality of binary values is broken up into a sequence of words having a size of n+1. Each of the words contains at least 3 letters. The words are encoded by changing letter spacing by decreasing or increasing the letter spacing from the initial spacing. If a respective word represents one, the letter spacing is increased by a first predefined value. If the respective word represents zero, the letter spacing is reduced by the first predefined value. If the respective word follows n-m, the letter spacing is increased or reduced by a second predefined value, different from the first predefined value.

### CROSS-REFERENCE TO RELATED APPLICATION

This application claims benefit of priority under 35 U.S.C. 119(a)-(d) to a Russian Application No. 2020129344 filed on Sep. 4, 2020, which is incorporated by reference herein.

### FIELD OF TECHNOLOGY

The present technical solution relates to computer systems, and more particularly relates to techniques for providing hidden encoding of a document text to be displayed on a screen or on a printed medium.

### BACKGROUND

Documents play a critical role in today's society. Given the increasing complexity of documents, there is a correspondingly increasing problem of marking documents for their subsequent identification in document management. Digital watermarking (sometimes termed “data hiding” or “data embedding”) is a growing field of endeavor, with several different approaches. It should be noted, however, that a document may be subject to external modification despite the presence of a digital watermark, or a digital watermark may be removed.

There are still yet-unsolved problems associated with leakage of documents containing confidential information from secure computer systems. As is well known in the art, such leakage by the photography of information from computer screens or from printed media has become a cause for substantial concern. In existing solutions, when open access to confidential data are detected, the distribution channel of the information cannot be identified. This problem is serious when there are many geographically distributed users working with restricted information.

### SUMMARY

Disclosed are systems and methods for steganographic text encoding.

Advantageously, the disclosed aspects provide hidden from the user encoding of a document text to be displayed on a screen or on a printed medium.

Aspects of the present disclosure feature the hidden steganographic encoding of information, which enables the necessary encryption to be automated in order to ensure security. These aspects of the disclosure make it practically impossible to determine clearly whether or not any additional information is encrypted in the document. If such information is encrypted it cannot be read by an unauthorized user. Also, the provided text encoding method enables the code to be preserved if the text is transferred from one medium to another, regardless of whether the medium is digital or printed.

The object of one or more aspects of the present disclosure is a method for steganographic text encoding, in which a message text received from a server is converted into a plurality of binary values. The text of the document represented by the plurality of binary values is broken up into a sequence of words having a size of n+1. Each of the words contains at least 3 letters.

The words are encoded by changing letter spacing by decreasing or increasing the letter spacing from the initial spacing. If a respective word represents one, the letter spacing is increased by a first predefined value. If the respective word represents zero, the letter spacing is reduced by the first predefined value.

If the respective word follows n-m, the letter spacing is increased or reduced by a second predefined value, different from the first predefined value.

In one aspect, message texts from the server are selectively provided to users using automatic filters.

In one aspect, each word in the sequence of words represents one, zero or a divider.

In one aspect, the divider word is used to indicate an end of a preceding sequence and a start of a following sequence.

In one aspect, the server stores a list of users and the levels of access to documents assigned to each user.

In one aspect, the information encrypted in the message text is an identifier of the user.

In one aspect, the information encrypted in the message text is an identifier of the document from the user.

### BRIEF DESCRIPTION OF THE DRAWINGS

The accompanying drawings, which are incorporated into and constitute a part of this specification, illustrate one or more example aspects of the present disclosure and, together with the detailed description, serve to explain their principles and implementations.

FIG. 1 shows a block diagram of an exemplary system for stenographic text encoding.

FIG. 2 illustrates an exemplary method for steganographic encoding of a message text.

FIG. 3. illustrates an exemplary method for processing a text block that has previously been converted into a sequence of zeros and ones.

FIG. 4 shows an example of a general-purpose computer system.

### DETAILED DESCRIPTION

Exemplary aspects are described herein in the context of a system, method, and computer program product for stenographic text encoding. Those of ordinary skill in the art will realize that the following description is illustrative only and is not intended to be in any way limiting. Other aspects will readily suggest themselves to those skilled in the art having the benefit of this disclosure. Reference will now be made in detail to implementations of the example aspects as illustrated in the accompanying drawings. The same reference indicators will be used to the extent possible throughout the drawings and the following description to refer to the same or like items

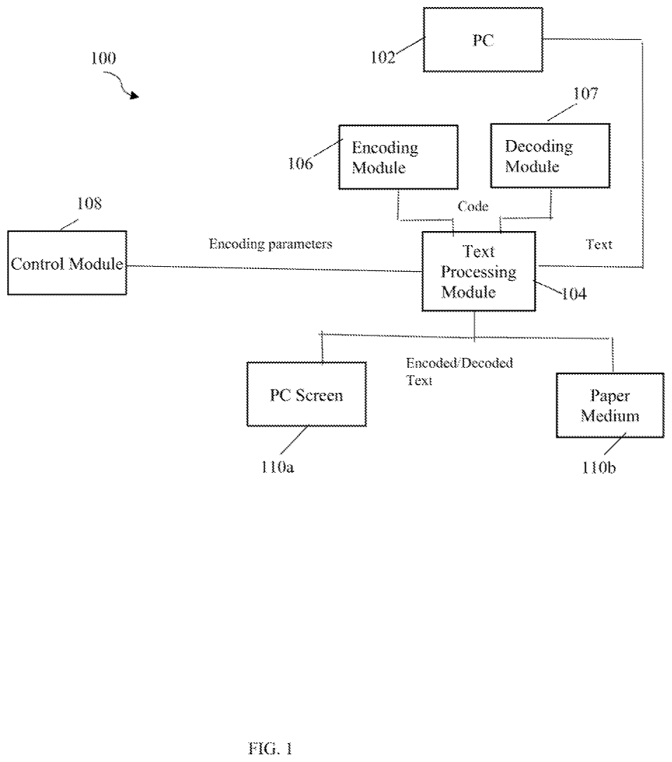

FIG. 1 a block diagram of an exemplary system for steganographic text encoding. The proposed system 100 may include a computing device such as a personal computer (hereafter “PC”) 102, a text processing module (subsystem) 104, an encoding module (subsystem) 106, a decoding module 107, a control module (subsystem) 108, and a display device 110, including for example, but not limited to, a PC screen 110a and/or a paper medium 110b.

The text processing module 104, may be configured to convert the text of a message from alphanumeric to binary and back, on the basis of the binary value of each Unicode symbol, for example.

The encoding module 106, may be configured to process the binary sequence produced from the message text, using an encryption algorithm, and may be configured to encrypt the information into a binary form. The decoding module 107 may be configured to perform the reverse transformation from the encrypted information to a binary sequence.

When a user has requested the document comprising the message text, the control module 108 may enable him to determine whether or not the user is entitled to consult/edit the document or to create a new document, based on user's access level, for example. The control module 108 may be implemented so that it can install automatic filters for the selective provision of documents from the server to the user. Examples of such automatic filters may be exclusions, in which only a restricted circle of personnel (users) is entitled to access and work with documents marked as containing commercial or state secrets. Document marking and sorting may grade employees according to their access to specified sections of the server disk space, and may provide files containing documents with specified markers in their code to determine the corresponding access category.

The control module 108 may also include a list of users and the levels of access to documents assigned to each user. Such information may be stored in the server. When an unauthorized user attempts to request access, it may be desirable to refuse the request and send a notification of the attempted access to a security personnel of the company.

All the data and information used by the system 100 in the present example may be stored on a server. However, in some variant aspects, the information may also be stored on the PC 102 and other known information storage devices.

The system 100 may further convert a content-rich part of the document being output on the screen 110a and/or on the printed medium 110b in such a way that the text is encoded with additional information without any loss of the initial data. The conversion may be performed in a manner so that the conversion is not readily perceptible to the user and does not affect his work with the document. For example, an identifier of the user who is currently examining or printing out the document may be encoded in the text. In this case, if a leak is detected, the security personnel of the affected organization may be able to deduce the source of the leak.

Thus, the system 100 enables text to be processed before being output on the screen 110a or on the paper medium 110b.

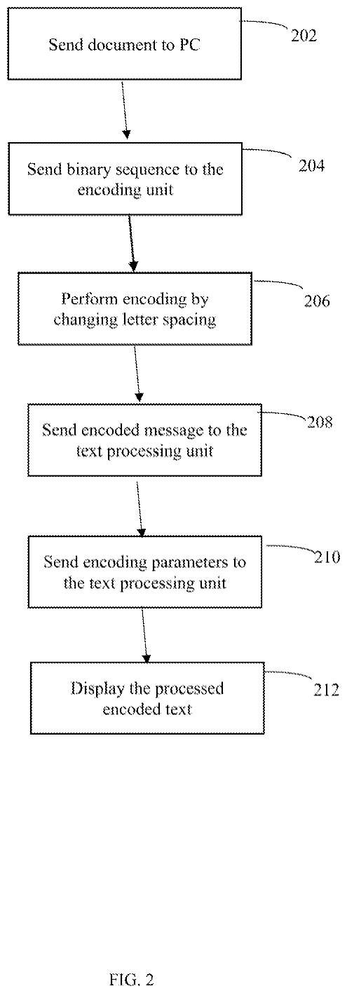

FIG. 2 illustrates an exemplary method for steganographic encoding of a message text.

At 202, after receiving a request from a user to receive a document from the server, the system 200 may send the document, containing confidential data, to the PC 102 where encoding takes place.

In a particular aspect, the text may be created directly, using the PC 102 (the text generation step).

At 204, the control module 108 may send the text, subject to encoding with additional information, along the internal communication channels of the system 100 to the text processing module 104. The control module 108 may automatically generate the type and values of the additional information that are determined based on the requirements of the organization. The control module 108 may send the received message text to the text processing module 104 which may be communicatively connected to the encoding module 106 and to the user's display device 110. The text processing module 104 may send the resulting binary sequence to the encoding module 106, which encodes the received message text in the following manner.

At 206, the encoding module 106 may convert the received message text into a sequence of ones and zeros. The resulting sequence may have a length n, that is to say a line of n characters, each of which is represented by a value of 1 or 0. The text of the document in which the encoding is carried out may be broken up by the encoding module 106 into sequences of words with a size of n+1, each of the words containing at least 3 letters. Thus each word in the sequence may represent 1 or 0 in the initial sequence of ones and zeros.

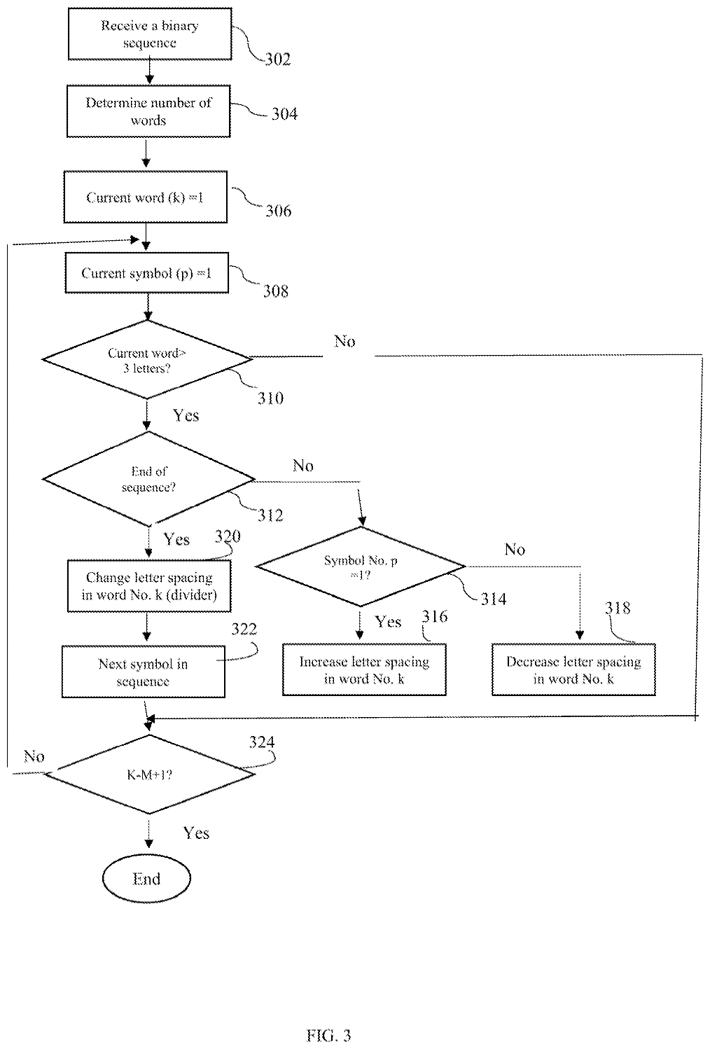

In one aspect, the encoding module 106 may encode the words by changing the letter spacing to decrease or increase it from the initial spacing, depending on the settings, as shown in FIG. 3.

If a word represents one, the encoding module 106 may increase the letter spacing by a specified value.

If a word represents zero, the encoding module 106 may decrease the letter spacing by a specified value.

If a word in a sequence follows n-m, then the encoding module 106 may increase or decrease the letter spacing by a specified value which may be different from the value used for the zeros and ones. This word is a divider, and may be used to determine the end of a preceding sequence and the start of the following sequence.

In an aspect, as a result of the encoding operations, the overall formatting of the received text may be changed to an insignificant degree and may be hidden for the user.

Thus, after the encoding module 106 performs encoding, the received text takes the form of a cyclic sequence of words, each of which represents one, zero, or a divider.

When code words with changed letter spacing are identified, it is possible to deduce which character is encoded in at least one of the code words.

Thus a sequence of zeros and ones is obtained by the encoding module 106 from the received message text. In an aspect, the text processing module 104 may deduce the exact nature of the information encoded in the text based on this sequence.

In an aspect, the encoding module 106 may send the encoded message text back to the text processing module 104 (at 208). When the changed message text is output from the text processing module 106, the message text may be converted back into a text consisting of symbols in the initial language, without visible changes.

As a result, the information encoded into the message text in the document is encapsulated in the document requested or generated by the user, in addition to the initial text.

At 210, the control module 108 may send the encoding parameters to the text processing module 104, and may check the users' authorization for the document and other settings of the system parameters. In an aspect, the settings may relate to the initial letter spacing. In turn, the initial letter spacing may depend on the font used for the document and on the form in which the document is to be produced.

At 212, the text processing module 104 may then send the processed encoded text to the display device 110, for example a PC monitor 110a or a printer. Advantageously, regardless of the method by which it is displayed, the processed text has a unique fingerprint. In an aspect, the encoding of the received text enables the code encoded into the document to be preserved even if the received text is transferred from one medium to another, regardless of whether the medium is digital 110a or printed 110b. Advantageously, the disclosed method for encoding data enables the encoding to be preserved because it is attached to the received text. If the encoded text is altered, by either mechanical transformation or the use of recognition systems, for example, the value of the processed encoded document is reduced to nothing.

FIG. 3. illustrates an exemplary method for processing a text block that has previously been converted into a sequence of zeros and ones. As used herein the term “word” refers to a sequence of zeros and ones combined into blocks. Each block may consist of at least 3 symbols. The disclosed system may determine the number of symbols in each block based on the system settings. In an aspect, the number of symbols may depend on the type of text encoding utilized by the disclosed system. After the information for encoding has been converted into binary form by the text processing module 104 (at 204), the resulting block of zeros and ones is sent sequentially to the encoding module 106 for processing the block of words from the converted text document. In an aspect, the encoding module 106 may be configured to make changes based on the steps shown in the FIG. 3 and described below.

At 302, the encoding module 106 may receive a binary sequence and information about the size of the binary sequence from the text processing module 104.

At 304, the encoding module 106 may determine the number of words in the received sequence.

At 306, the encoding module 106 may assign a value of 1 to the number of current word (k).

At 308, the encoding module 106 may assign a value of 1 to the current symbol in the received sequence (p).

At 310, the encoding module 106 may determine if the currently processed word contains more than three (3) letter. In response to determining that the currently processed word does not contain more than three letters (decision block 310, “No” branch), the encoding module 106 may advance execution of the method to step 324 described below. In response to determining that the currently processed word contains more than three letters (decision block 310, “Yes” branch), at 312, the encoding module 106 may determine whether an end of the sequence has been encountered. In other words, the encoding module 106 may determine whether p is equal to N.

In response to determining that the end of the sequence has not been encountered yet (decision block 312, “No” branch), at 314, the encoding module 106 may determine whether the value of the currently processed symbol (p) is equal to 1. In response to determining that the value of the currently processed symbol (p) is equal to 1 (decision block 314, “Yes” branch), the encoding module 106 may increase the letter spacing in the currently processed word (k) by the specified value (at 316). In response to determining that the value of the currently processed symbol (p) is not equal to 1 (decision block 314, “No” branch), the encoding module 106 may decrease the letter spacing in the currently processed word (k) by the specified value (at 318).

In response to determining that the end of the sequence has been encountered (decision block 312, “Yes” branch), at 320, the encoding module 106 may determine that a divider word has been reached. As noted above, the divider word may be used to determine the end of a preceding sequence and the start of the following sequence.

As shown in FIG. 3, at 322, the encoding module 106 may advance processing to the next symbol in the sequence by increasing the values of p and k by 1, for example. At 324, the encoding module 106 may determine if the currently processed word exceeds the total number of words in the sequence. In other words, at 324, the encoding module 106 may determine if k is equal to M+1. In response to determining that all words have been processed (decision block 324, “Yes” branch), the execution of the described method ends. However, if not all words have been processed yet, the encoding module 106 may return back to step 308 described above.

In an aspect, the steganographic text encoding may be decrypted using a decoding module 107 configured to implement the steps described below. In an aspect, the decoding module 107 may process the document received via input devices, for example. Upon receiving the document, the decoding module 107 may recognize the information content. Furthermore, the decoding module 107 may extract the quantity of values of the letter spacings from the text content. In an aspect, based on the obtained information, the decoding module 107 may extract the bit values representing original text from the received document, using the reverse application of the steganographic text encoding method described below:
if the letter spacing is increased by a value greater than the specified spacing value, it is considered to be a one;
if the letter spacing is increased by a value smaller than the specified spacing value, it is considered to be a zero;
if the value differs from the specified value after the resulting sequence of zeros and ones, then this word is a divider. As noted above, the divider is used to determine the end of a preceding sequence and the start of the following sequence.

In an aspect, the decoded information may be converted back into readable text by the text processing module 104. Next, the text processing module 104 may send the readable text to the screen 110a and/or paper medium 110b or other output component of user's device. In an aspect, the decoding module 107 may be a component of a separate system for decrypting steganographic text encoding which is similar to the encryption system shown in FIG. 1. Both implementations of the system may include at least one client device and one server, consisting of a processor connected to a memory. The client device may include: the text processing module 104 configured to translate the document text into a sequence of zeros and ones and/or translate a sequence of zeros and ones into document text; an encoding module 106/decoding module 107 that may be configured to implement the encryption/decryption methods described above. At least one server connected to the client device by a network may include the control module 108.

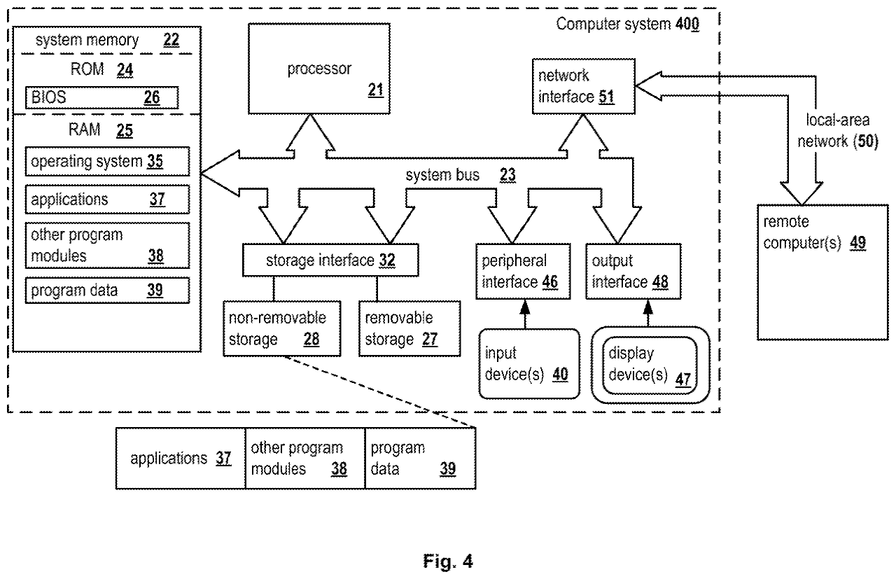

FIG. 4 is a block diagram illustrating a computer system 400 on which aspects of systems and methods for steganographic text encoding may be implemented in accordance with an exemplary aspect. The computer system 400 may represent the computer system of FIG. 1 hosting the encoding/decoding module and can be in the form of multiple computing devices, or in the form of a single computing device, for example, a desktop computer, a notebook computer, a laptop computer, a mobile computing device, a smart phone, a tablet computer, a server, a mainframe, an embedded device, and other forms of computing devices.

As shown, the computer system 400 includes a central processing unit (CPU) 21, a system memory 22, and a system bus 23 connecting the various system components, including the memory associated with the central processing unit 21. The system bus 23 may comprise a bus memory or bus memory controller, a peripheral bus, and a local bus that is able to interact with any other bus architecture. Examples of the buses may include PCI, ISA, PCI-Express, HyperTransport™, InfiniBand™, Serial ATA, I²C, and other suitable interconnects. The central processing unit 21 (also referred to as a processor) can include a single or multiple sets of processors having single or multiple cores. The processor 21 may execute one or more computer-executable code implementing the techniques of the present disclosure. The system memory 22 may be any memory for storing data used herein and/or computer programs that are executable by the processor 21. The system memory 22 may include volatile memory such as a random access memory (RAM) 25 and non-volatile memory such as a read only memory (ROM) 24, flash memory, etc., or any combination thereof. The basic input/output system (BIOS) 26 may store the basic procedures for transfer of information between elements of the computer system 400, such as those at the time of loading the operating system with the use of the ROM 24.

The computer system 400 may include one or more storage devices such as one or more removable storage devices 27, one or more non-removable storage devices 28, or a combination thereof. The one or more removable storage devices 27 and non-removable storage devices 28 are connected to the system bus 23 via a storage interface 32. In an aspect, the storage devices and the corresponding computer-readable storage media are power-independent modules for the storage of computer instructions, data structures, program modules, and other data of the computer system 400. The system memory 22, removable storage devices 27, and non-removable storage devices 28 may use a variety of computer-readable storage media. Examples of computer-readable storage media include machine memory such as cache, static random access memory (SRAM), dynamic random access memory (DRAM), zero capacitor RAM, twin transistor RAM, enhanced dynamic random access memory (eDRAM), extended data output random access memory (EDO RAM), double data rate random access memory (DDR RAM), electrically erasable programmable read-only memory (EEPROM), NRAM, resistive random access memory (RRAM), silicon-oxide-nitride-silicon (SONOS) based memory, phase-change random access memory (PRAM); flash memory or other memory technology such as in solid state drives (SSDs) or flash drives; magnetic cassettes, magnetic tape, and magnetic disk storage such as in hard disk drives or floppy disks; optical storage such as in compact disks (CD-ROM) or digital versatile disks (DVDs); and any other medium which may be used to store the desired data and which can be accessed by the computer system 400.

The system memory 22, removable storage devices 27, and non-removable storage devices 28 of the computer system 400 may be used to store an operating system 35, additional program applications 37, other program modules 38, and program data 39. The computer system 400 may include a peripheral interface 46 for communicating data from input devices 40, such as a keyboard, mouse, stylus, game controller, voice input device, touch input device, or other peripheral devices, such as a printer or scanner via one or more I/O ports, such as a serial port, a parallel port, a universal serial bus (USB), or other peripheral interface. A display device 47 such as one or more monitors, projectors, or integrated display, may also be connected to the system bus 23 across an output interface 48, such as a video adapter. In addition to the display devices 47, the computer system 400 may be equipped with other peripheral output devices (not shown), such as loudspeakers and other audiovisual devices

The computer system 400 may operate in a network environment, using a network connection to one or more remote computers 49. The remote computer (or computers) 49 may be local computer workstations or servers comprising most or all of the aforementioned elements in describing the nature of a computer system 400. Other devices may also be present in the computer network, such as, but not limited to, routers, network stations, peer devices or other network nodes. The computer system 400 may include one or more network interfaces 51 or network adapters for communicating with the remote computers 49 via one or more networks such as a local-area computer network (LAN) 50, a wide-area computer network (WAN), an intranet, and the Internet. Examples of the network interface 51 may include an Ethernet interface, a Frame Relay interface, SONET interface, and wireless interfaces.

Aspects of the present disclosure may be a system, a method, and/or a computer program product. The computer program product may include a computer readable storage medium (or media) having computer readable program instructions thereon for causing a processor to carry out aspects of the present disclosure.

The computer readable storage medium can be a tangible device that can retain and store program code in the form of instructions or data structures that can be accessed by a processor of a computing device, such as the computing system 400. The computer readable storage medium may be an electronic storage device, a magnetic storage device, an optical storage device, an electromagnetic storage device, a semiconductor storage device, or any suitable combination thereof. By way of example, such computer-readable storage medium can comprise a random access memory (RAM), a read-only memory (ROM), EEPROM, a portable compact disc read-only memory (CD-ROM), a digital versatile disk (DVD), flash memory, a hard disk, a portable computer diskette, a memory stick, a floppy disk, or even a mechanically encoded device such as punch-cards or raised structures in a groove having instructions recorded thereon. As used herein, a computer readable storage medium is not to be construed as being transitory signals per se, such as radio waves or other freely propagating electromagnetic waves, electromagnetic waves propagating through a waveguide or transmission media, or electrical signals transmitted through a wire.

Computer readable program instructions described herein can be downloaded to respective computing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network interface in each computing device receives computer readable program instructions from the network and forwards the computer readable program instructions for storage in a computer readable storage medium within the respective computing device.

Computer readable program instructions for carrying out operations of the present disclosure may be assembly instructions, instruction-set-architecture (ISA) instructions, machine instructions, machine dependent instructions, microcode, firmware instructions, state-setting data, or either source code or object code written in any combination of one or more programming languages, including an object oriented programming language, and conventional procedural programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a LAN or WAN, or the connection may be made to an external computer (for example, through the Internet). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present disclosure.

In various aspects, the systems and methods described in the present disclosure can be addressed in terms of modules. The term “module” as used herein refers to a real-world device, component, or arrangement of components implemented using hardware, such as by an application specific integrated circuit (ASIC) or field-programmable gate array (FPGA), for example, or as a combination of hardware and software, such as by a microprocessor system and a set of instructions to implement the module's functionality, which (while being executed) transform the microprocessor system into a special-purpose device. A module may also be implemented as a combination of the two, with certain functions facilitated by hardware alone, and other functions facilitated by a combination of hardware and software. In certain implementations, at least a portion, and in some cases, all, of a module may be executed on the processor of a computer system. Accordingly, each module may be realized in a variety of suitable configurations, and should not be limited to any particular implementation exemplified herein. In the interest of clarity, not all of the routine features of the aspects are disclosed herein. It would be appreciated that in the development of any actual implementation of the present disclosure, numerous implementation-specific decisions must be made in order to achieve the developer's specific goals, and these specific goals will vary for different implementations and different developers. It is understood that such a development effort might be complex and time-consuming, but would nevertheless be a routine undertaking of engineering for those of ordinary skill in the art, having the benefit of this disclosure. Furthermore, it is to be understood that the phraseology or terminology used herein is for the purpose of description and not of restriction, such that the terminology or phraseology of the present specification is to be interpreted by the skilled in the art in light of the teachings and guidance presented herein, in combination with the knowledge of the skilled in the relevant art(s). Moreover, it is not intended for any term in the specification or claims to be ascribed an uncommon or special meaning unless explicitly set forth as such.

The various aspects disclosed herein encompass present and future known equivalents to the known modules referred to herein by way of illustration. Moreover, while aspects and applications have been shown and described, it would be apparent to those skilled in the art having the benefit of this disclosure that many more modifications than mentioned above are possible without departing from the inventive concepts disclosed herein.

1. A method of steganographic text encoding, the method comprising:
installing automatic filters configured to selectively provide a user with message texts from a server;
selectively providing the user with a message text if user's access category matches an access category associated with the message text;
converting the message text received from the server into a plurality of binary values;
breaking up the text of the document represented by the plurality of binary values into a sequence of words having a size of n+1, wherein each of the words contains at least 3 symbols;
encoding the text of the document by encoding the words by changing letter spacing by decreasing or increasing the letter spacing from the initial spacing, wherein the information encoded in the message text is an identifier of the user currently examining the message text and wherein if a respective word represents one, the letter spacing is increased by a first predefined value;
if the respective word represents zero, the letter spacing is reduced by the first predefined value;
if the respective word represents a divider word, the letter spacing is increased or reduced by a second predefined value, different from the first predefined value;
decoding the encoded text of the document prior to displaying the document to the user by converting the encoded text of the document into the message text received from the server; and
displaying the message text to the user.

2. (canceled)

3. The method of claim 1, wherein each word in the sequence of words represents one, zero or a divider word.

4. The method of claim 3, wherein the divider word is used to indicate an end of a preceding sequence and a start of a following sequence.

5. The method of claim 1, wherein the server stores a list of users and the levels of access to documents assigned to each user.

6. (canceled)

7. The method of claim 1, wherein the information encoded in the message text is an identifier of the document from the user.

8. A system for providing steganographic text encoding, the system comprising:
a hardware processor configured to:
install automatic filters configured to selectively provide a user with message texts from a server;
selectively provide the user with a message text if user's access category matches an access category associated with the message text;
convert the message text received from the server into a plurality of binary values;
break up the text of the document represented by the plurality of binary values into a sequence of words having a size of n+1, wherein each of the words contains at least 3 symbols;
encode the text of the document by encoding the words by changing letter spacing by decreasing or increasing the letter spacing from the initial spacing, wherein the information encoded in the message text is an identifier of the user currently examining the message text and wherein if a respective word represents one, the letter spacing is increased by a first predefined value;
if the respective word represents zero, the letter spacing is reduced by the first predefined value;
if the respective word represents a divider word, the letter spacing is increased or reduced by a second predefined value, different from the first predefined value;
decode the encoded text of the document prior to displaying the document to the user by converting the encoded text of the document into the message text received from the server; and
display the message text to the user.

9. (canceled)

10. The method of claim 8, wherein each word in the sequence of words represents one, zero or a divider word.

11. The system of claim 10, wherein the divider word is used to indicate an end of a preceding sequence and a start of a following sequence.

12. The system of claim 8, wherein the server stores a list of users and the levels of access to documents assigned to each user.

13. (canceled)

14. The system of claim 8, wherein the information encoded in the message text is an identifier of the document from the user.

15.-20. (canceled)
